(19) United States
(12) Patent Application Publication
(10) Pub. No.: US 2014/0166421 A1
(43) Pub. Date: Jun. 19, 2014

(54) RATCHET BICYCLE HUB ASSEMBLY

(71) Applicant: JOY INDUSTRIAL CO., LTD., Taichung Hsien (TW)

(72) Inventor: CHUN-HSUNG CHEN, TAICHUNG HSIEN (TW)

(73) Assignee: JOY INDUSTRIAL CO., LTD., TAICHUNG HSIEN (TW)

(21) Appl. No.: 13/713,183

(22) Filed: Dec. 13, 2012

(51) Int. Cl. F16D 41/30

(52) U.S. Cl. CPC F16D 41/30
USPC 192/45.1

(57) ABSTRACT

A bicycle hub assembly includes a hub with an axle extending therethrough. A socket is connected to the hub and has a base connected thereto. The base has multiple pawl recesses and each pawl recess has two receiving portions. A ratchet unit has multiple pawls, multiple resilient members and a toothed ring. The pawls each have a first protrusion and a second protrusion respectively extending from one end thereof. A restriction slot is defined in one side of the pawl. The two ends of the resilient member are respectively received in the two ends of the pawl recess. Each resilient member has a curved contact portion which contacts the restriction slot. The toothed ring is located in the hub and the pawls are engaged with the toothed ring. When the first protrusion is worn out, the second protrusion is engaged with the ratchet teeth and the hub assembly works normally.

### FIELD OF THE INVENTION

The present invention relates to a hub assembly, and more particularly, to a bicycle hub assembly with two pawls to ensure the functions to be normally operated.

### BACKGROUND OF THE INVENTION

The conventional hub assembly is located between the gear cluster and the wheel, and the hub assembly drives the wheel to move forward. The conventional hub assembly generally comprises a hub with an axle extending therethrough. A socket and a toothed ring are connected to one end of the hub, and the socket has a pawl unit which is cooperated with the toothed ring. The pawl unit comprises multiple pawls and each pawl is biased by a resilient member. The pawls are engaged with the toothed ring so as to drive the hub via the socket. When the pawls and the toothed ring are rotated in opposite directions, the pawls are disengaged from the toothed ring and compress the resilient members, such that the hub is rotated independently from the pawls which cannot drive the hub.

The resilient members can be torsion springs or resilient bands. Taiwan Patent Application No. 096118831 discloses a hub assembly having an axle and a driving member which is rotatably connected to the axle. A hub is rotatably mounted to the axle and a transmission device is located between the driving member and the hub so as to transmit force to the hub via a first transmission path and a second transmission path. Multiple pawls are located between the hub and the driving member to transfer torques when the torques are transmitted via the first transmission path. A return device restricts the movement of the pawls when the torques are transmitted via the second transmission path. The return device comprises springs which drive the return device to be engaged with the pawls when the torques are transmitted via the second transmission path.

Another hub assembly with resilient bands is disclosed in Taiwan Patent Application No. 096131291 and comprises a hub with an axle extending through a passage thereof, and the hub has an inner periphery which has multiple engaging recesses defined radially therein. Each engaging recess has a trapezoidal recess. A ratchet wheel co-axially mounted to the axle and has a reception slot defined in the outer periphery thereof. The outer periphery of the ratchet wheel is located corresponding to the inner periphery of the hub. A pawl has one end pivotably engaged with one of the two ends of the reception slot and the other end of the pawl is engaged with one of the engaging recesses and contacts against the inside of the engaging recess. A resilient member has one end selectively received in the other end of the reception slot and the other end of the resilient member contacts the pawl so as to provide a force to return the pawl to its initial position.

For Taiwan Patent Application No. 096118831, the transmission device is located between the driving member and the hub, and the pawls are cooperated with springs and the pawls are located in the recesses of the driving member. The torques are transmitted from either the first transmission path or the second transmission path. The pawls are located between the hub and the driving member to transfer torques. The pawls are biased to be engaged with the toothed ring to drive the hub. When the driving member rotates in the opposite direction, the springs are in contact with the pawls which are returned and disengaged from the toothed ring. There is no noise generated when the pawls are returned. For Taiwan Patent Application No. 096131291, there is only one pawl and the pawl can be worn out after longer time of operation and cannot be firmly engaged with the engaging recess to affect the transmission. Because the pawl is installed without restriction member to secure its position so that the pawl may be disengaged from the engaging recess from lateral side by vibration or impact, or the pawl may be stocked in the engaging recess. Besides, the pivotal end of the pawl has a sharp angle which may stock the pawl. Besides, there is no sealing member located between the hub and socket, water and foreign objects easily enter into the hub assembly to cause rusting problems.

The present invention intends to provide a bicycle hub assembly which improves the shortcomings of the existed hub assemblies.

### SUMMARY OF THE INVENTION

The present invention relates to a bicycle hub assembly and comprises a hub and an axle extends centrally through the hub. A reception recess is defined in one end of the hub. A socket is connected to the hub and has a stepped portion a base is connected to the stepped portion. The base has multiple pawls recesses and each pawl recess has a first receiving portion and a second receiving portion in two ends thereof. A ratchet unit has multiple pawls, multiple resilient members and a toothed ring, wherein the pawls each have a connection end at the first end thereof. A first protrusion and a second protrusion respectively extend from the second end of each pawl. A restriction slot is defined in one side of the pawl and located in opposite to the first and second protrusions. The connection ends are respectively engaged with the first receiving portions. The resilient members each have a first end a second end, the first end of each resilient member is located in the second receiving portion and the second end of each resilient member has a curved contact portion which contacts the restriction slot. The base has a fixing member which stops the pawls. The toothed ring is located in the reception recess and has multiple ratchet teeth. The socket is connected to one end of the hub and mounted to the axle. The pawls are engaged with the ratchet teeth.

The primary object of the present invention is to provide a hub assembly wherein when the first protrusion of the pawls is worn out, the second protrusion is engaged with the ratchet teeth so as to ensure that the hub assembly works normally.

The second object of the present invention is to provide a hub assembly wherein the base has a fixing member which stops the pawls from disengaging from the base.

The third object of the present invention is to provide a hub assembly wherein the pawl has a restriction slot defined therein and two contact sides respectively extend from two sides of the restriction slot. The contact portion of the resilient member contacts the restriction slot and is stopped by the contact sides such that the resilient member is not disengaged laterally. The curved contact portion does not interfere the operation of the pawl.

The fourth object of the present invention is to provide a hub assembly wherein a fixing member is located between the hub and the socket, another fixing member is located between the socket and the hub, such that water and foreign objects cannot enter the hub assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hub assembly of the present invention;

FIG. 2 is an exploded view to show the hub assembly of the present invention;

FIG. 3 shows the enlarged view of the pawl of the hub assembly of the present invention;

FIG. 4 is a cross sectional view of the hub assembly of the present invention;

FIG. 5 is a side cross sectional view of the hub assembly of the present invention;

FIG. 6 is an enlarged cross sectional view of the hub assembly of the present invention;

FIG. 7 is an enlarged cross sectional view to show the operation of the pawl of the hub assembly of the present invention, and

FIG. 8 is another enlarged cross sectional view to show the operation of the pawl of the hub assembly of the present invention.

### DETAILED DESCRIPTION OF THE PREFERRED EMBODIMENT

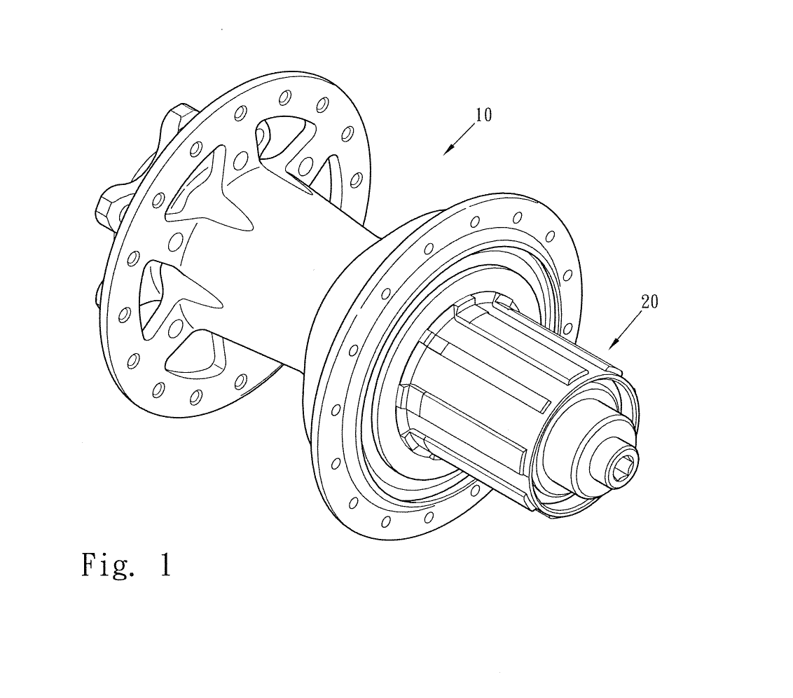

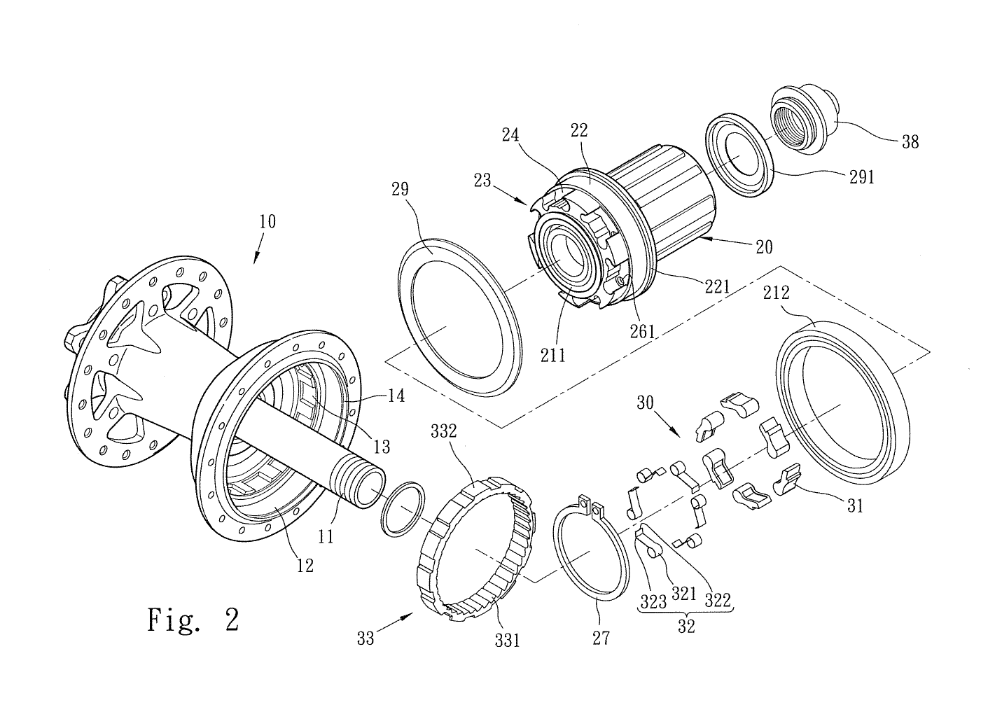

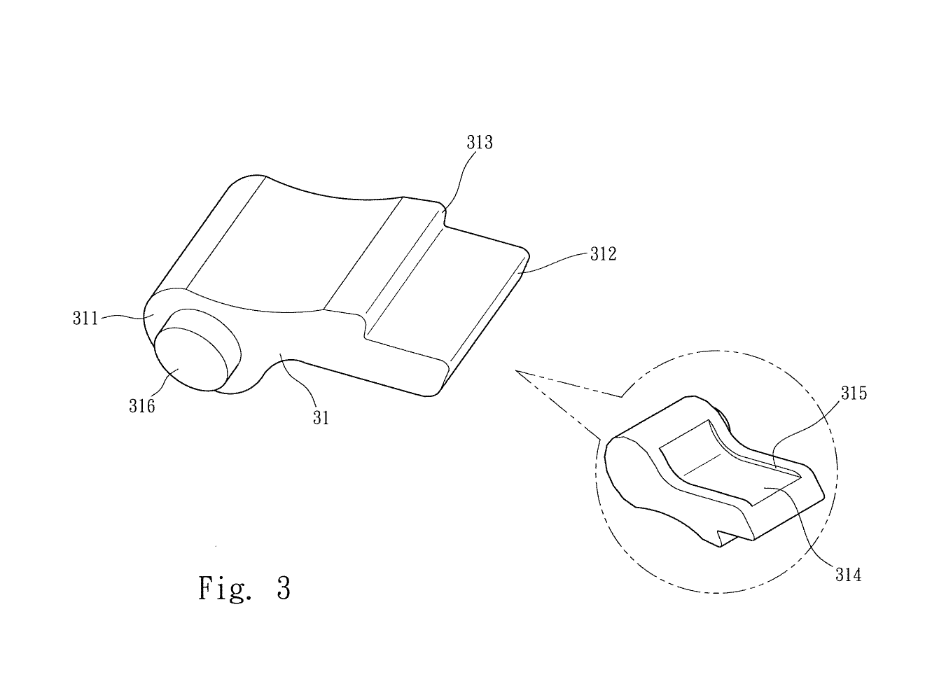

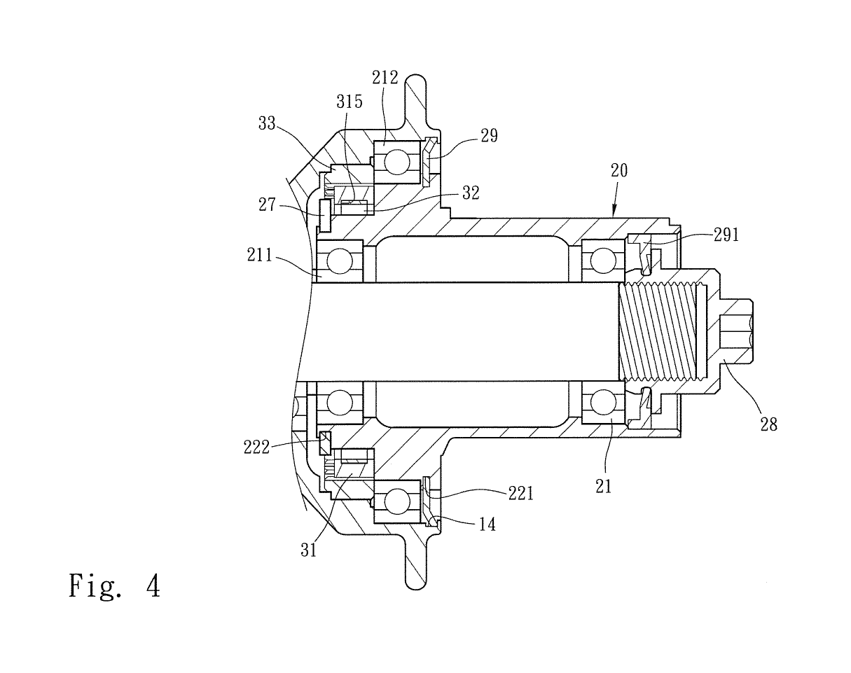

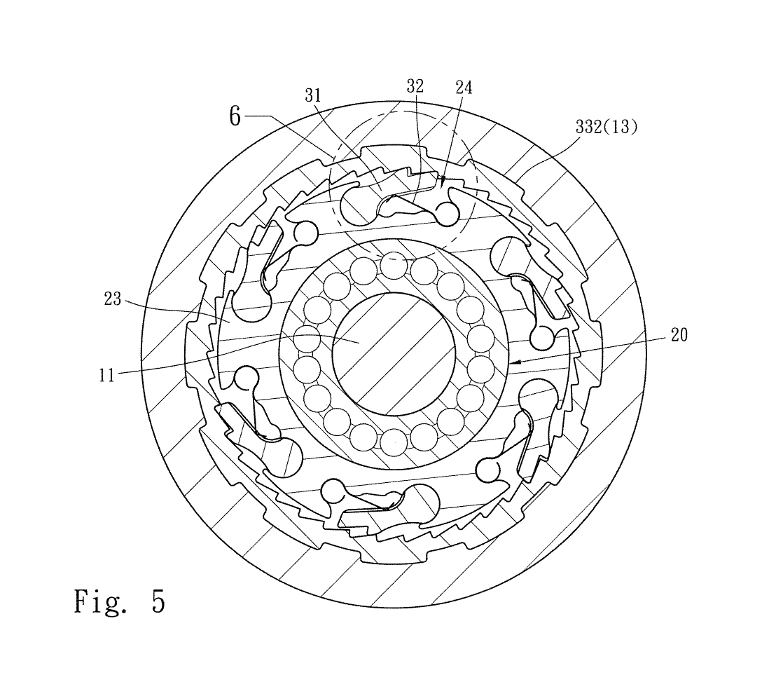

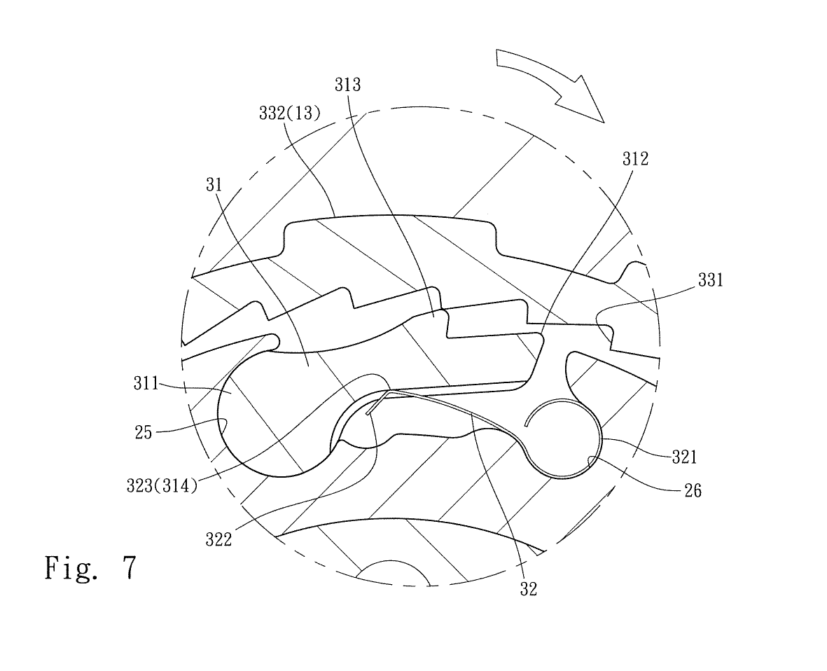

Referring to FIGS. 1 to 8, the hub assembly of the present invention comprises a hub 10, a socket 20 connected to one end of the hub 10 and a ratchet unit 30.

The hub 10 is a hollow member and an axle 11 extends centrally through the hub 10. A reception recess 12 is defined in one end of the hub 10 and has multiple engaging recesses 13 or protrusions. In this embodiment, there are twelve engaging recesses 13 or protrusions in axial direction. A first groove 14 is defined radially in the inner periphery of a flange extending from the end having the reception recess 12.

The socket 20 has two bearings 21, 211 located in two ends thereof and a gear cluster is connected to the socket 20. A stepped portion 22 is formed on the outer periphery of the socket 20 and a second groove 221 is defined in the stepped portion 22.

A base 23 is integrally formed with the stepped portion 22 and the base 23 has multiple pawls recesses 24. The pawl recesses 24 are unevenly spaced located along the outer periphery of the base 23. Each pawl recess 24 has a first receiving portion 25 and a second receiving portion 26 in two ends thereof The first receiving portion 25 has a first pivotal portion 261 at the inside thereof and the first pivotal portion 261 is a recess or a protrusion.

The ratchet unit 30 has multiple pawls 31, multiple resilient members 32 and a toothed ring 33, wherein the pawls 31 are respectively located in the pawl recesses 24. Each pawl 31 having a curved connection end 311 at the first end thereof, and a first protrusion 312 and a second protrusion 313 respectively extend from the second end of each pawl 31. The first protrusion 312 is located on the second end of the pawl 31 and the second protrusion 313 is located between the connection end 311 and the first protrusion 312. A restriction slot 314 is defined in one side of the pawl 31 and located in opposite to the first and second protrusions 312, 313. Two contact sides 315 respectively extend from two sides of the restriction slot 314. The connection end 311 has a second pivotal portion 316 at one side thereof and the second pivotal portion 316 is a protrusion or a recess. The connection end 311 is located in the first receiving portion 25. The first and second pivotal portions 261, 316 are engaged with each other. The first and second protrusions 312, 131 extend outward from the pawl 31 which is pivoted relative to the first receiving portion 25.

The resilient member 32 is an elongate member and has a first end 321 and a second end 322, wherein the first end 312 bends toward one side of the resilient member 32 to form a circular portion which is located in the second receiving portion 26. The second end 322 of the resilient member 32 is bent an angle. A bent contact portion 323 is formed between the second end 322 and the first end 321. The first and second ends 321, 322 are bent in opposite directions. The contact portion 323 contacts the restriction slot 314 of the pawl 31 to provide the force for returning the pawl 31. The contact portion 323 is stopped by the two contact sides 315 and is not disengaged from lateral side. The base 23 has a notch 222 defined therein and a fixing member 27 is engaged with the notch 222, wherein the fixing member 27 can be a ring-shaped member or a C-shaped member. The fixing member 27 contacts the pawls 31 so as to prevent the pawls 31 from disengaged from the pawl recesses 24.

The toothed ring 33 is located in the reception recess 12 and has multiple ratchet teeth 331 defined in the inner periphery thereof. The toothed ring 33 has twelve protrusions 332 or recesses, the engaging recesses 13/protrusions of the reception recess 12 are engaged with the protrusions 332/recesses of the toothed ring 33. The engagement between the twelve protrusions 332 and recesses 13 increase the torque to be transmitted. A connection member 28 is located at the distal end of the socket 20 so as to connect the socket 20 to the axle 11. The bearing 212 is located between the reception recess 12 and the stepped portion 22. The first protrusions 312 of the pawls 31 are engaged with the ratchet teeth 331. A distance “L” is formed between the second protrusion 313 and the ratchet teeth 331. A second stop member 291 is located between the socket 20 and the connection member 29. By the first and second stop members 29, 291, water and foreign objects cannot enter into the hub assembly. By the engagement between the pawls 31 and the ratchet teeth 331, when the socket 20 rotates, the hub 10 and the toothed ring 33 are co-rotated with the socket 20. When the socket 20 rotates in the opposite direction, the pawls 31 are compressed by the ratchet teeth 331 so that the resilient members 32 are compressed, the first protrusions 312 are disengaged from the ratchet teeth 331, such that the hub 10 is not driven and which rotates in one direction.

When the first protrusion 312 is worn out, the second protrusion 313 is engaged with the ratchet teeth 331 to ensure that the hub assembly works normally. The contact portion 323 is a curved portion and is engaged with the restriction slot 314 of the pawl 31, so as to avoid the pawl 31 from being stocked.

When assembling the hub assembly, the toothed ring 33 is installed in the reception recess 12 of the hub 10, and the pawls 31 are engaged with the first receiving portions 25 of the base 23. The resilient members 32 are engaged with the second receiving portion 26. The fixing member 27 is engaged with the notch 222, and the socket 20 is connected to the hub 10 and mounted to the axle 11. The base 23 is located in the reception recess 12 and the first protrusions 312 of the pawls 31 are engaged with the ratchet teeth 331 of the toothed ring 33. The first stop member 29 is located between the reception recess 12 and the stepped portion 22. The connection member 28 is securely locked to the axle 11. The second stop member 291 is installed between the socket 20 and the connection member 28.

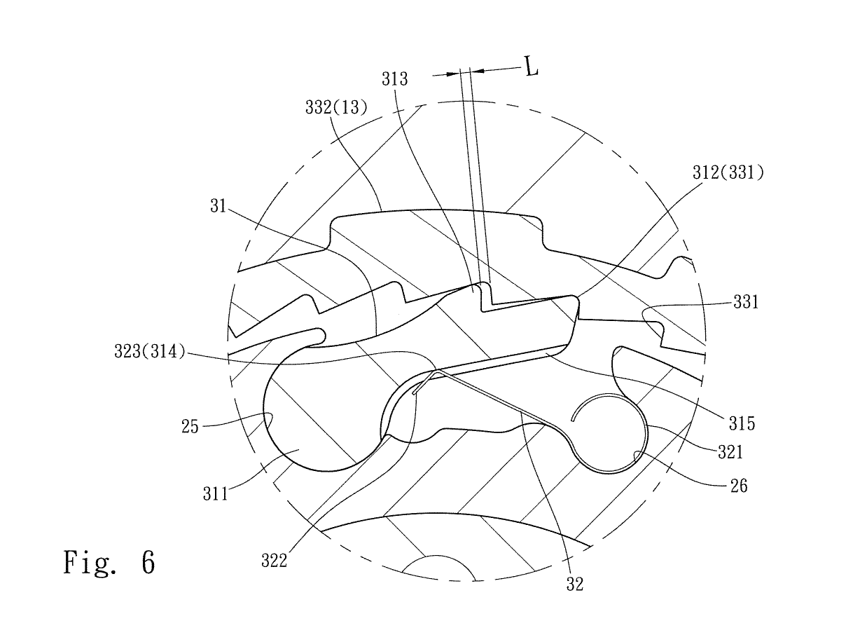

When in use, as shown in FIG. 6, the rotation of the socket 20 drives the hub 10 and the toothed ring 33 by the engagement between the first protrusions 312 and the ratchet teeth 331. On the contrary, when the socket 20 rotates in the opposite direction, the pawls 31 are compressed by the ratchet teeth 331 so that the resilient members 32 are compressed. The first protrusions 312 are disengaged from the ratchet teeth 331, such that the hub 10 is not driven by the socket 20 and the hub 10 rotates in one direction. Because the pawl recesses 24 are unevenly spaced, so that when one of the pawls 31 is engaged with the ratchet tooth 331, the next pawl 31 is ready for engagement with another ratchet tooth 331, so that when the socket 20 is rotated independently from the hub 10 and then rotates in opposite direction, the next pawl 31 is engaged with the closest ratchet tooth 331 to drive he hub 10.

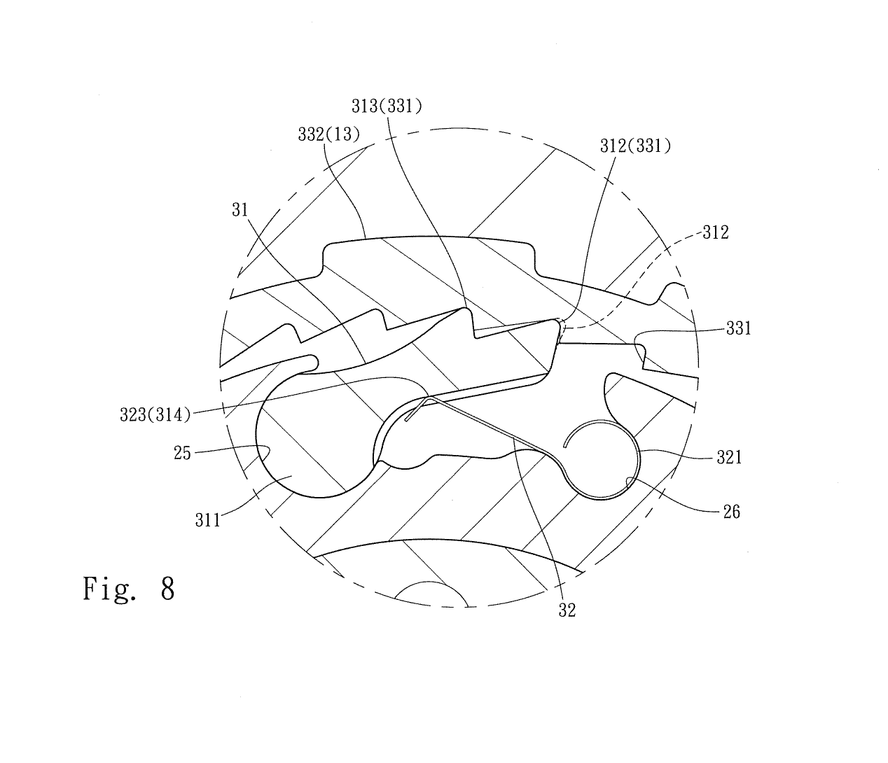

When the first protrusion 321 of the pawl 31 is engaged with the ratchet tooth 331, the second protrusion 313 of the pawl 31 is also engaged with the ratchet tooth 331 with a gap “L” defined therebetween. In other words, the first protrusion 312 drives the toothed ring 33 and the hub 10. When the first protrusion 312 is worn out, as shown in FIG. 8, the first protrusion 321 of the pawl 31 cannot engage with the ratchet tooth 331, and the second protrusion 313 is then engaged with the ratchet tooth 331 and the first protrusion 312 is located between the ratchet teeth 331 to eliminate the gap between the first protrusion 312 and the ratchet teeth 331. The second protrusion 313 then drives the toothed ring 33 and the hub 10 to ensure that the hub assembly works normally. The use of the first and second protrusions 321, 313 can keep the hub 10 to be functioned as desired without frequently changing the pawls 31. Besides, the fixing member 27 on the side of the socket 20 prevents the pawls 31 from disengaging from the base 23 from the lateral side.

The two contact sides 315 respectively extend from the two sides of the restriction slot 314, the contact portion 323 of the resilient member 32 contacts the restriction slot 314 of the pawl 31 and restricted by the contact sides 315 so that the resilient member 32 is not disengaged from the lateral side. The curved contact portion 323 does not interfere the pawls 31. The first and second stop members 29, 291 avoid water and foreign objects from entering into the hub 10.

The engagement of the twelve recesses 13 and the protrusions 332 between the reception recess 12 and the toothed ring 33 allow higher torque to be transmitted.

While we have shown and described the embodiment in accordance with the present invention, it should be clear to those skilled in the art that further embodiments may be made without departing from the scope of the present invention.

What is claimed is:

1. A bicycle hub assembly comprising:
a hub being a hollow member and an axle extending centrally through the hub, a reception recess defined in one end of the hub;
a socket having gear cluster connected thereto, a stepped portion formed on an outer periphery of the socket and a base connected to the stepped portion, the base having multiple pawls recesses and each pawl recess having a first receiving portion and a second receiving portion in two ends thereof, and
a ratchet unit having multiple pawls, multiple resilient members and a toothed ring, the pawls each having a connection end at a first end thereof, a first protrusion and a second protrusion respectively extending from a second end of each pawl, a restriction slot defined in a side of the pawl and located in opposite to the first and second protrusions, the connection ends of the pawls being respectively engaged with the first receiving portions, the resilient members each having a first end a second end, the first end of each resilient member located in the second receiving portion and the second end of each resilient member having a curved contact portion which contacts the restriction slot, the base having a fixing member which stops the pawls, the toothed ring located in the reception recess and having multiple ratchet teeth, the socket connected to one end of the hub and mounted to the axle, the pawls engaged with the ratchet teeth.

2. The hub assembly as claimed in claim 1, wherein the hub has a first groove defined radially in an inner periphery of a flange extending from the end having the reception recess, the stepped portion has a second groove, a first top member is engaged between the first and second grooves, a connection member is located at a distal end of the socket and connected the socket to the axle, a second stop member is located between the socket and the connection member.

3. The hub assembly as claimed in claim 1, wherein the pawl recesses are unevenly spaced located along an outer periphery of the base and each pawl recess has the first receiving portion and the second receiving portion, the connection end of each pawl is a curved end, an angle is defined between the first and second protrusions, the first protrusion is located at the second end of the pawl and the first protrusion is located between the first end of the pawl and the second protrusion, the connection end is located in the first receiving portion, the first protrusion is engaged with the ratchet teeth, a distance is formed between the second protrusion and the ratchet teeth corresponding thereto, when the first protrusion is worn out, the second protrusion is engaged with the ratchet tooth.

4. The hub assembly as claimed in claim 1, wherein the pawl recesses are unevenly spaced located along an outer periphery of the base and each pawl recess has the first receiving portion and the second receiving portion, the first receiving portion has a first pivotal portion at an inside thereof and the first pivotal portion is a recess or a protrusion, the connection end of each pawl is a curved end, an angle is defined between the first and second protrusions, the connection end has a second pivotal portion at one side thereof and the second pivotal portion is a protrusion or a recess, the connection end is located in the first receiving portion, the first and second pivotal portions are engaged with each other.

5. The hub assembly as claimed in claim 1, wherein the resilient member has a first end and a second end, the first end bends toward a side of the resilient member to form a circular portion which is located in the second receiving portion, the second end of the resilient member is bent an angle, a bent contact portion is formed between the second end and the first end, the first and second ends are bent in opposite directions, two contact sides respectively extend from two sides of the restriction slot, the contact portion contacts the restriction slot of the pawl.

6. The hub assembly as claimed in claim 1, wherein the base has a notch defined therein and a fixing member is engaged with the notch.

7. The hub assembly as claimed in claim 1, wherein the fixing member is a ring-shaped member.

8. The hub assembly as claimed in claim 1, wherein the fixing member is a C-shaped member.

9. The hub assembly as claimed in claim 1, wherein the reception recess of the hub has twelve engaging recesses or protrusions and the toothed ring has twelve protrusions or recesses, the engaging recesses/protrusions of the reception recess are engaged with the protrusions/recesses of the toothed ring.
